(19) United States
(12) Patent Application Publication
(10) Pub. No.: US 2023/0382205 A1
(43) Pub. Date: Nov. 30, 2023

(54) Rodless Actuator; Rodless Actuator with Drive Element Positioned within a Rail Tube; Rail Mounted Retractable Cover; and Retractable Aerodynamic Apparatus for a Pick-up Truck

(71) Applicant: Adaptive Aerodynamic, LLC, Maple Grove, MN (US)

(72) Inventors: Thomas Scott BREIDENBACH, Maple Grove, MN (US); Jack David FEHRS, Minneapolis, MN (US)

(21) Appl. No.: 18/139,944

(22) Filed: Apr. 26, 2023

Related U.S. Application Data
(60) Provisional application No. 63/334,668, filed on Apr. 26, 2022.

(51) Int. Cl. B60J 7/057; B60J 7/04; B60J 7/047

(52) U.S. Cl. CPC B60J 7/0573; B60J 7/041; B60J 7/047

(57) ABSTRACT

The presently claimed and described technology provides an apparatus including a rodless actuator with actuated mount, a rodless actuator with drive element positioned within a rail tube, a rodless actuator with deterministic actuation, a rodless actuator system including a plurality of coordinated rodless actuators, a rail-mounted retractable cover including a pair of rails and a plurality of cover segments driven between a deployed configuration and a retracted configuration, a retractable aerodynamic apparatus for a pick-up truck including a plurality of panels and a pair of rails that drive the plurality of panels between a deployed configuration and a retracted configuration.

### CROSS REFERENCE TO RELATED APPLICATION

The present application claims the benefit of U.S. Provisional Patent Application Ser. No. 63/334,668, entitled Rodless Actuator with Deterministic Actuation; Rodless Actuator System with Coordinated Actuators; Rail Mounted Retractable Cover; and Retractable Aerodynamic Apparatus for a Pickup Truck, and filed on Apr. 26, 2022, the disclosure of which is hereby incorporated by reference in its entirety.

### FIELD

Various aspects of the presently disclosed and claimed technology relate to rodless actuators, rodless actuator systems, retractable covers, and retractable aerodynamic apparatuses, and the like.

### BACKGROUND

Commercially available pneumatic rodless cylinders provide benefits related to: a) a fixed geometry base; b) no rod-to-cylinder joint and thus no environmental exposure to a seal between the rod-to-cylinder joint; and c) a magnetic breakaway that may protect from overload and/or provide safety. However, pneumatic rodless cylinders do not provide deterministic actuation which may be desired and/or required in certain applications. Furthermore, pneumatic rodless cylinders require compressed air which may not be readily available in certain applications.

The above-mentioned benefits related to pneumatic rodless cylinders may be desired when a plurality of actuators is desired and/or required. However, using a plurality of pneumatic rodless cylinders in a system that requires close coordination between the pneumatic rodless cylinders is typically not possible because a suitably precise and deterministic move profile of pneumatic devices is difficult and thus leads to a lack of coordination and related crashes and/or binding of the driven system.

Commercially available covers are available for a wide variety of applications including machine tool bases, industrial equipment, and pick-up truck boxes. It is often desired to actuate such covers. In certain applications, it may be desirable to actuate such covers at a plurality of actuating points (e.g., at right and left sides to prevent binding). In such applications, using a single actuator may require connecting the single actuator to the plurality of actuating points. This may lead to undesirable connecting mechanisms, increased cost, decreased aesthetics, difficulty in packaging the connecting mechanisms, and/or increased environmental exposure to the connecting mechanisms. Alternatively, a plurality of actuators may be used at the plurality of actuating points, but close coordination of the actuators may be required. This may lead to difficulty in controlling and/or coordinating the multiple actuators (e.g., pneumatic actuators), increased cost, and increased environmental exposure to actuators (e.g., exposed lead screws).

Aftermarket and dealer supplied accessories for pick-up trucks may include pick-up truck box covers (i.e., tonneau covers), toppers (i.e., camper shells, box cap, etc.), side rails (i.e., bed side rails, bed racks, etc.), and racks (i.e., bed racks, etc.) that are positioned above the side of the pick-up truck box. However, such accessories may only provide a single function, may interfere with or be incompatible with other box side mounted accessories, and/or are not integrated with other box side mounted accessories.

Conventional pick-up trucks have poor aerodynamic efficiency and thus have decreased range for a given amount of fuel capacity and/or electric battery capacity. FIGS. 12A-12I of U.S. Pat. No. 10,994,792 B2—Aerodynamic Drag Reducing Apparatus, incorporated herein by reference in its entirety, and U.S. D926,085 S1—Vehicle Body (apparently a representation of the Tesla Cybertruck) illustrate pick-up trucks with improved aerodynamic efficiency and thus have increased range for a given amount of fuel capacity and/or electric battery capacity in comparison with similarly sized conventional pick-up trucks. Furthermore, the above-mentioned “aerodynamic” pick-up trucks are reconfigurable to allow access to a box of the pick-up trucks and an uncovering/recovering of the box, if needed or desired, to accommodate various uses. However, the apparent representation of the Tesla Cybertruck includes extended side panels behind the cab and above the limits of a conventional pick-up truck box that may be undesired (e.g., for aesthetics, visibility, incompatibility with accessory equipment, etc.).

Thus, there is a need for a rodless actuator with deterministic actuation, a rodless actuator system with coordinated actuators, a rail mounted retractable cover, and a retractable aerodynamic apparatus for a pick-up truck.

Further limitations and disadvantages of conventional and traditional prior art actuators, actuator systems, retractable covers, and aerodynamic apparatuses for pick-up trucks will become apparent to one of skill in the art, through comparison of such mechanisms and/or methods with certain aspects of the present disclosure, as set forth in the remainder of the present application with reference to the drawings.

### BRIEF SUMMARY

The present disclosure describes and illustrates a rodless actuator with deterministic actuation, a rodless actuator system with coordinated actuators, a rail mounted retractable cover (e.g., a retractable cover for a pick-up truck), and a retractable aerodynamic apparatus for a pick-up truck.

These and other advantages, aspects, and novel features of the present disclosure, as well as the details of illustrated embodiments thereof, will be more fully understood from the following description and drawings.

### BRIEF DESCRIPTION OF THE FIGURES

Embodiments of the present disclosure will now be described, by way of example only, with reference to the attached Figures, wherein:

FIG. 1 is a partial perspective view of an example retractable cover and the example deterministic actuating rail system of FIG. 21 roughly mounted over an example box of an example pick-up truck, shown in an extended (deployed) configuration, in accordance with the principles of the present disclosure;

FIG. 2A is a perspective view of the retractable cover of FIG. 1, shown in the extended configuration, the retractable cover actuated by an example deterministic actuating rail system, in accordance with the principles of the present disclosure;

FIG. 2B is a perspective view of the retractable cover of FIG. 1 and the actuating rail system of FIG. 2A, but shown in a retracted (stowed) configuration, in accordance with the principles of the present disclosure;

FIG. 2C is a cross-sectional elevation view of the retractable cover of FIG. 1 and the rail system of FIG. 2A, as called out at FIG. 2A, shown in the extended configuration;

FIG. 2D is a cross-sectional elevation view of the retractable cover of FIG. 1 and the rail system of FIG. 2A, as called out at FIG. 2B, shown in the retracted configuration;

FIG. 3A is a perspective view of another example retractable cover mounted over another example box of another example pick-up truck, shown in an extended (deployed) configuration, in accordance with the principles of the present disclosure;

FIG. 3B is a perspective view of the pick-up truck of FIG. 3A fitted with the retractable cover of FIG. 3A, but shown in a retracted (stowed) configuration, in accordance with the principles of the present disclosure;

FIG. 4A is a perspective view of still another example retractable cover with a front panel and a back panel with passages (pockets) to accommodate rail mounts, shown in an extended (deployed) configuration, in accordance with the principles of the present disclosure;

FIG. 4B is a partial front view of yet another example retractable cover with a back panel with passages (pockets) to accommodate rail mounts and a set of the guide protrusions and slides of FIGS. 23A-23D, in accordance with the principles of the present disclosure;

FIG. 4C is a perspective view of an example last panel suitable for use with the retractable covers of FIGS. 4A and/or 4B, but with a back panel with a door to, among other things, accommodate rail mounts, in accordance with the principles of the present disclosure;

FIG. 5A is a perspective view of still another example retractable cover with a front panel and a back panel with pockets/slots to accommodate rail mounts, shown in an extended (deployed) configuration, in accordance with the principles of the present disclosure;

FIG. 5B is the perspective view of FIG. 5A, but with the retractable cover shown in a retracted (stowed) configuration, in accordance with the principles of the present disclosure;

FIG. 6 is a perspective view of an example fairing that is suitable for use with the retractable covers of FIGS. 1, 3A, 4A, 4B, 5A, 22A, 23A, 24A, 25A, and/or 26A, in certain applications, in accordance with the principles of the present disclosure;

FIG. 7 is a partial perspective view of an example prior art pick-up truck that includes a pair of example prior art rear facing cameras;

FIG. 8A is a perspective view of an example prior art rail assembly suitable for use on the pick-up truck of FIG. 7;

FIG. 8B is an enlarged partial perspective view showing an example mount of the rail assembly of FIG. 8A;

FIG. 8C is a plan view of an example prior art mounting washer/adapter suitable for use at either or both ends of the rail assembly of FIG. 8A;

FIG. 8D is a perspective view of an example prior art mounting retainer suitable for use at either or both ends of the rail assembly of FIG. 8A for attaching the rail assembly to the pick-up trucks of FIGS. 1, 3A, 7, and/or 9A;

FIG. 9A is a perspective view of another example prior art pick-up truck that includes a pair of the box-mounted rail assemblies of FIG. 8A;

FIG. 9B is a partial side view of the pick-up truck and rail assemblies of FIG. 9A;

FIG. 10 is a schematic cross-sectional side view of an example deterministic actuating rail system with example magnetic coupling assemblies that is suitable for use with the retractable covers of FIGS. 1, 3A, 4A, 4B, 5A, 22A, 23A, 24A, 25A, and/or 26A, in accordance with the principles of the present disclosure;

FIG. 11 is a schematic cross-sectional top view of the rail system with the magnetic coupling assemblies of FIG. 10, in accordance with the principles of the present disclosure;

FIG. 12 is a schematic cross-sectional side view of another example deterministic actuating rail system, but with example external threads and an example drive nut, that is suitable for use with the retractable covers of FIGS. 1, 3A, 4A, 4B, 5A, 22A, 23A, 24A, 25A, and/or 26A, in accordance with the principles of the present disclosure;

FIG. 13 is a schematic cross-sectional side view of the deterministic actuating rail system of FIG. 12, but with an example alternative internal motor configuration, in accordance with the principles of the present disclosure;

FIG. 14A is an enlarged portion of FIG. 2C, as called out at FIG. 2C;

FIG. 14B is an enlarged portion of FIG. 2D, as called out at FIG. 2D;

FIG. 15A is a perspective view of the actuating rail system of FIG. 2A, in accordance with the principles of the present disclosure;

FIG. 15B is an exploded and broken perspective view of the actuating rail system of FIG. 2A, in accordance with the principles of the present disclosure;

FIG. 15C is an exploded perspective view of an example drive system and an example first mount suitable for use with the actuating rail system of FIG. 2A, in accordance with the principles of the present disclosure;

FIG. 15D is an exploded and broken perspective view of an example screw assembly suitable for use with the actuating rail system of FIG. 2A, in accordance with the principles of the present disclosure;

FIG. 16A is a perspective view of an example second mount suitable for use with the actuating rail system of FIG. 2A, in accordance with the principles of the present disclosure;

FIG. 16B is an exploded perspective view of the second mount of FIG. 16A;

FIG. 17A is a perspective view of an example inner magnetic couple and an example nut assembly suitable for use with the actuating rail system of FIG. 2A, in accordance with the principles of the present disclosure;

FIG. 17B is an exploded perspective view of the inner magnetic couple and the nut assembly of FIG. 17A, in accordance with the principles of the present disclosure;

FIG. 17C is a reverse exploded perspective view of the nut assembly of FIG. 17A;

FIG. 18A is a perspective view of an example outer magnetic couple and an example panel mount suitable for use with the actuating rail system of FIG. 2A, in accordance with the principles of the present disclosure;

FIG. 18B is a partial exploded perspective view of the outer magnetic couple and the panel mount of FIG. 18A, in accordance with the principles of the present disclosure;

FIG. 19 is a cross-sectional perspective view of an example variation of the drive system and the first mount of FIG. 15C, in accordance with the principles of the present disclosure;

FIG. 20A is a partial cut-away cross-sectional perspective view of an example variation of the drive system and the first mount of FIGS. 15C and 19, in accordance with the principles of the present disclosure;

FIG. 20B is the partial cut-away cross-sectional perspective view of FIG. 20A, but with a rail tube removed;

FIG. 21 is a cross-sectional perspective view of a pair of example roller systems suitable for use in respectively supporting and guiding the inner magnetic couple and the nut assembly of FIG. 17A and/or the outer magnetic couple and the panel mount of FIG. 18A, in accordance with the principles of the present disclosure;

FIGS. 22A-22D are schematic cross-sectional partial top views of a side portion of a retractable cover driven by the actuating rail system of FIGS. 10 and/or 12 and mounted to a pick-up truck box, in accordance with the principles of the present disclosure;

FIG. 22E is an enlarged portion of FIG. 22A, as called out at FIG. 22A, illustrating mating lips, locating features, guides, magnet locations, and seals suitable for use with the retractable covers of FIGS. 1, 3A, 4A, 4B, 5A, 22A, 23A, 24A, 25A, and/or 26A, in accordance with the principles of the present disclosure;

FIG. 22F is an enlarged portion of FIG. 22B, as called out at FIG. 22B, illustrating locating features, guides, magnet locations, and seals suitable for use with the retractable covers of FIGS. 1, 3A, 4A, 4B, 5A, 22A, 23A, 24A, 25A, and/or 26A, in accordance with the principles of the present disclosure;

FIGS. 23A-23D are schematic cross-sectional partial top views of the side portion of the retractable cover and actuating rail system mounted to the pick-up truck box of FIGS. 22A-22D, further showing a set of guide protrusions and slides, in accordance with the principles of the present disclosure;

FIGS. 24A-24D are schematic cross-sectional partial top views of a side portion of another retractable cover driven by the actuating rail system of FIGS. 10 and/or 12 and mounted to the pick-up truck box of FIGS. 22A-22D, in accordance with the principles of the present disclosure;

FIGS. 25A-25D are schematic cross-sectional partial top views of a side portion of still another retractable cover mounted to a pick-up truck box, showing a deployment sequence and linear slides of the cover, in accordance with the principles of the present disclosure;

FIGS. 26A-26D are schematic cross-sectional partial top views of the side portion of the retractable cover of FIGS. 25A-25D, further showing travel limiters of the retractable cover at the deployment sequence of the cover, in accordance with the principles of the present disclosure;

FIGS. 27A and 27B are schematic cross-sectional partial top views of the side portion of the retractable cover of FIGS. 25A-25D, further showing latches of the retractable cover to implement the deployment sequence of the cover, in accordance with the principles of the present disclosure; and

FIGS. 28A-28E are partial cross-sectional side views of the retractable cover of FIG. 5A illustrating a bi-stable element (e.g., a linkage or a spring-form) for deterministic actuation of the retractable covers of FIGS. 1, 3A, 4A, 4B, 5A, 22A, 23A, 24A, 25A, and/or 26A, in accordance with the principles of the present disclosure.

### DETAILED DESCRIPTION

Various embodiments will be described in detail with reference to the drawings, wherein like reference numerals represent like parts and assemblies throughout the several views. It is to be understood that this disclosure is not limited to the particular methodology and examples described herein and as such may vary. It is also to be understood that the terminology used herein is for the purpose of describing particular embodiments only and is not intended to limit the scope of the present disclosure or the appended claims.

As used herein and in the appended claims, the singular forms “a”, “an”, and “the” include plural reference unless the context clearly indicates otherwise.

Unless defined otherwise, all technical and scientific terms used herein have the same meaning as commonly understood to one of ordinary skill in the art to which this disclosure belongs.

According to the principles of the present disclosure, a retractable cover (i.e., a retractable cover system), called out in various forms in the drawings by reference number 50, is adapted to cover a box 150 of a pick-up truck, called out in various forms in the drawings by reference number 100. The retractable cover 50 may be configured (i.e., converted, reconfigured, etc.) between an extended configuration 360 (i.e., a deployed configuration, etc.) and a retracted configuration 370 (i.e., a stowed configuration, etc.).

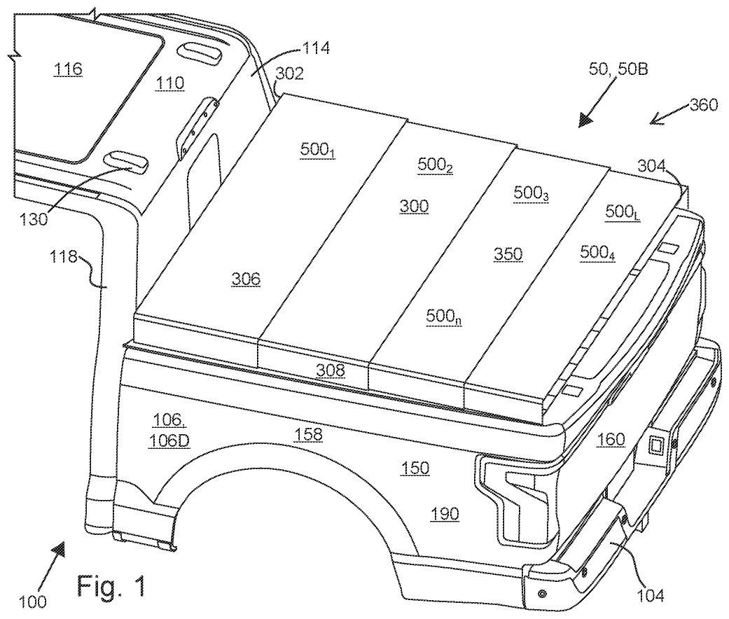

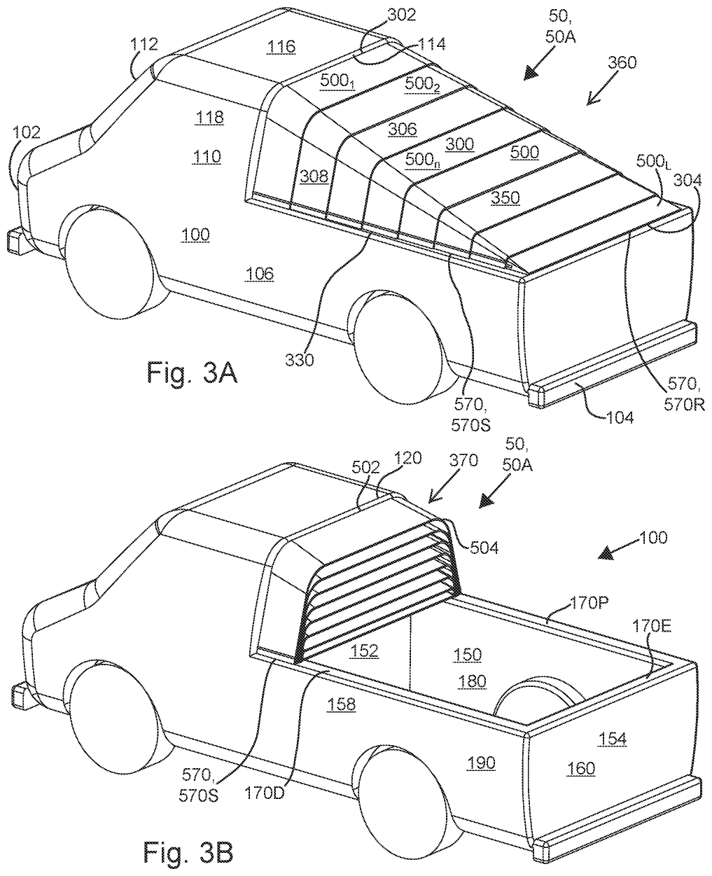

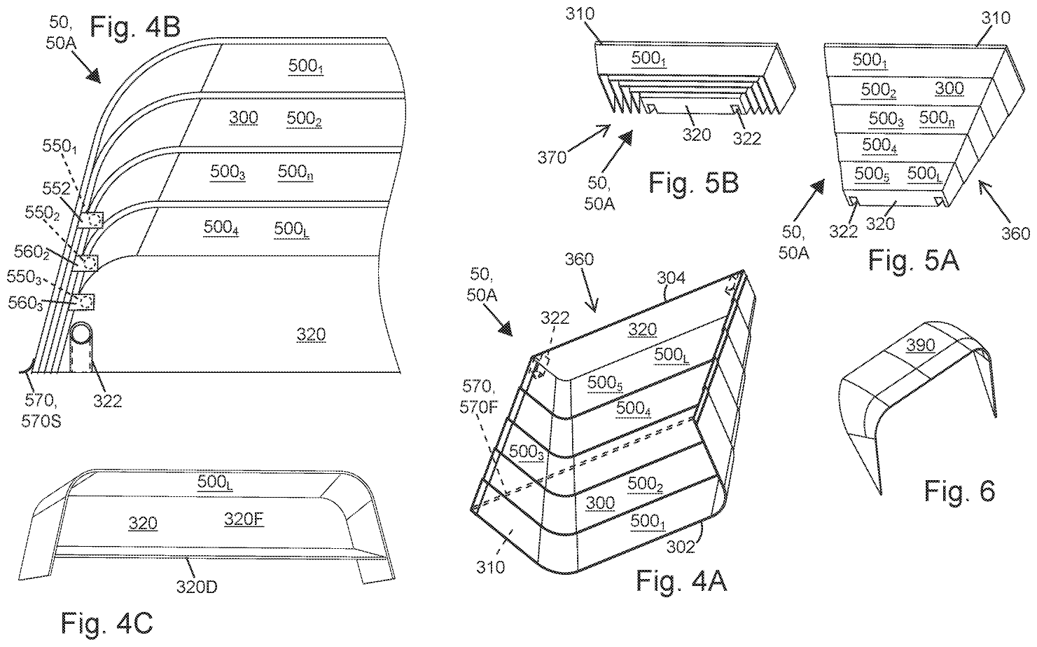

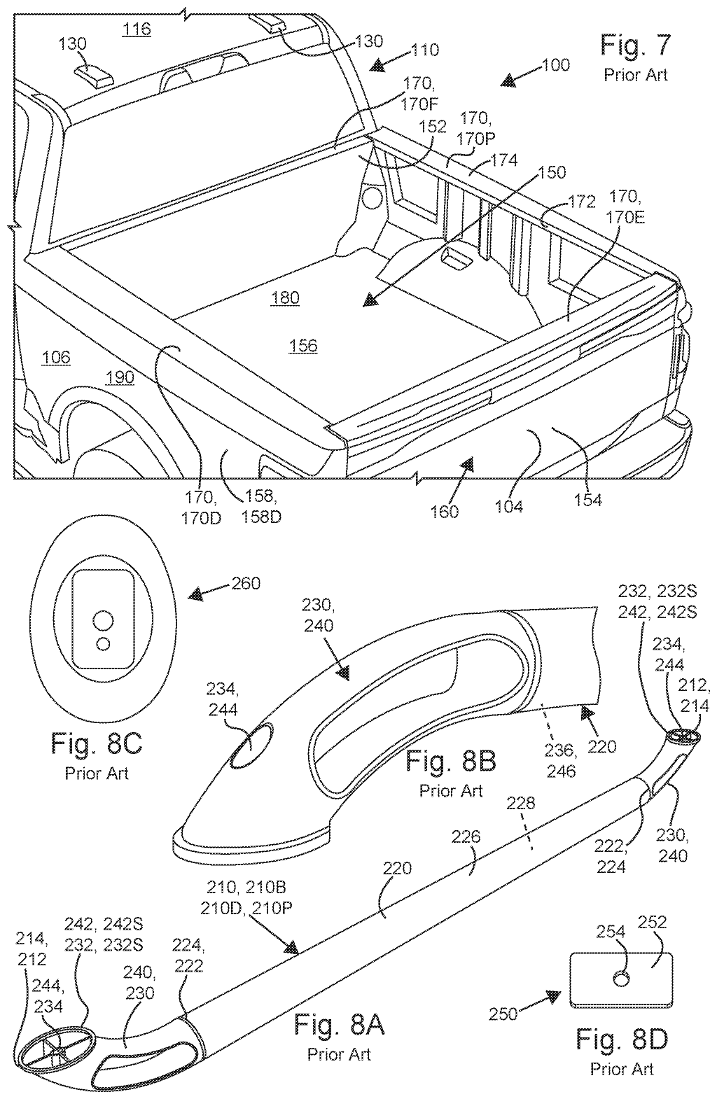

Various examples of pick-up trucks 100 are illustrated at FIGS. 1, 3A, 3B, 7, 9A, and 9B. The pick-up truck 100 extends between a front end 102 and a rear end 104 and between sides 106. As illustrated, a cab 110 of the pick-up truck 100 is typically positioned between the box 150 and the front end 102, and the box 150 is typically positioned between the cab 110 and the rear end 104. The cab 110 and the box 150 are typically positioned adjacent each other (i.e., a rear end 114 of the cab 110 is positioned adjacent a front end 152 of the box 150). The cab 110 extends between a front end 112 and the rear end 114 and between sides 118. In the examples depicted at FIGS. 1 and 7, rear facing cameras 130 are positioned at a roof 116 of the cab 110 and may extend slightly above a contour 120 (see FIG. 3B) of the cab 110.

In certain embodiments, the retractable cover 50 may improve aerodynamic performance of the pick-up truck 100, especially when in the extended configuration 360 and/or when the pick-up truck 100 is traveling at highway speeds. When in the extended configuration 360 of certain aerodynamic improving embodiments, the retractable cover 50 may slope downwardly as it extends rearwardly, as shown on a retractable cover 50, 50A at FIGS. 3A and 3B. An angle of downward slope from horizontal may be from 10-18 degrees. In certain depicted embodiments, the angle of downward slope from horizontal is 12 degrees or about 12 degrees. In other embodiments, other sloping angles may be used. The downward slope may be clear of or only minimally interfere with a field-of-view of the rear facing camera(s) 130.

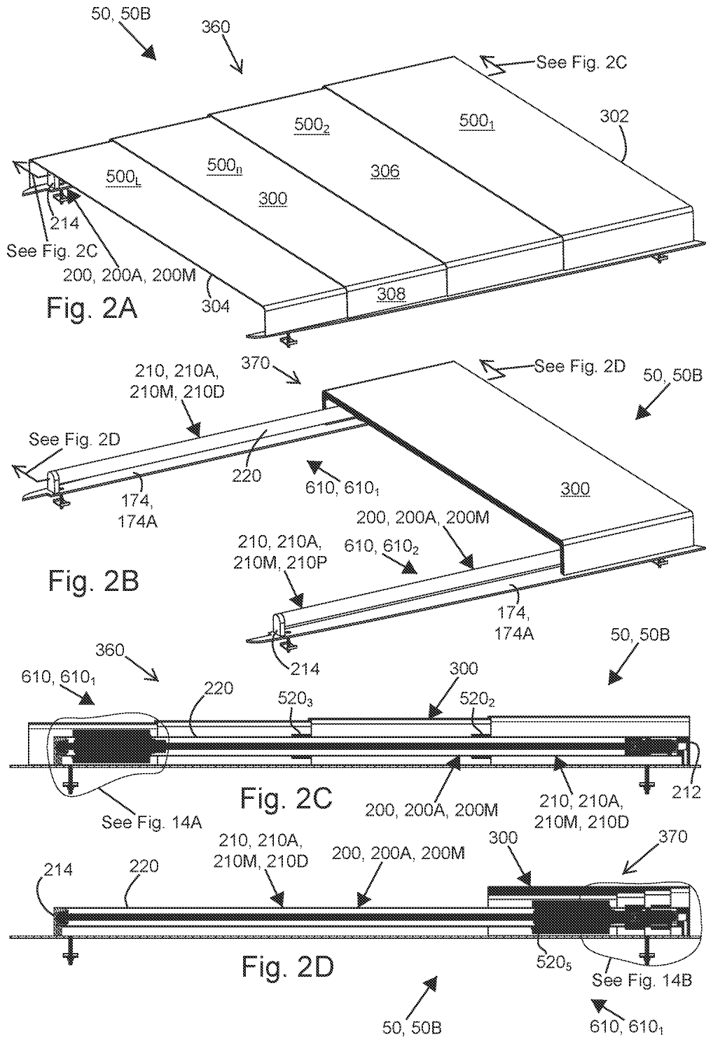

In other embodiments, the retractable cover 50 may have a small or no overall slope, as shown on a retractable cover 50, 50B at FIGS. 1, 2A, and 2B. In such embodiments, the retractable cover 50, 50B may generally have an overall shape of a conventional cover, topper, camping shell, etc. for a pick-up truck 100. For example, in certain embodiments, the retractable cover 50, 50B may be just above a top 170 of the box 150 of the pick-up truck 100 (e.g., similar to a tilt-up one-piece tonneau cover). In certain embodiments, the retractable cover 50, 50B may be substantially horizontal or piece-wise horizontal. In certain embodiments, the retractable cover 50 or a portion of the retractable cover 50 may be substantially flush with the top 170 of the box 150 of the pick-up truck 100 (e.g., similar to a fold-up or roll-up tonneau cover).

According to the principles of the present disclosure, the retractable cover 50, 50A, 50B may include a plurality of panels 500, 500ₙ (e.g., panel assemblies, sheets, covers, hoops, etc.). In certain embodiments, the plurality of panels 500, 500ₙ nest together when in the retracted configuration 370. In certain embodiments, the plurality of panels 500, 500ₙ may partially nest together when in the extended configuration 360.

According to the principles of the present disclosure, the retractable cover 50 may include one or more rails that guide at least some of the plurality of panels 500, 500ₙ as the retractable cover 50 reconfigures between the retracted configuration 370 and the extended configuration 360. The one or more rails may further support at least some of the plurality of panels 500, 500ₙ when the retractable cover 50 is at the retracted configuration 370, the extended configuration 360, and/or between the retracted configuration 370 and the extended configuration 360. In certain depicted embodiments, a rail arrangement 200 includes a pair of rail assemblies 210 that guide at least some of the plurality of panels 500, 500ₙ. As depicted, the pair of rail assemblies 210 includes a driver's side rail assembly 210D, positioned on a driver's side 158D of the box 150, and a passenger's side rail assembly 210P, positioned on a passenger's side 158P of the box 150. The driver's side and passenger's side orientations (i.e., a driver's side 106, 106D and a passenger's side 106, 106P of the pick-up truck 100) are shown according to the typical configuration found in the United States of America. Other configurations, e.g., typically found in England, may be opposite to that shown herein.

According to the principles of the present disclosure, the rail arrangement 200 may include various characteristics and/or features. As mentioned above, the rail arrangement 200 may be used to guide and/or support at least some of the plurality of panels 500, 500ₙ, of the retractable cover 50. In certain embodiments, the rail arrangement 200 may drive at least some of the plurality of panels 500, 500ₙ and thereby configure/reconfigure the retractable cover 50 from and/or to the retracted configuration 370 and/or from and/or to the extended configuration 360. As used in the present disclosure, the reference number 200 generically applies to basic rail arrangements 200B, described in detail hereinafter, and actuating rail arrangements 200A, described in detail hereinafter. Similarly, as used in the present disclosure, reference number 210 generically applies to various rail assemblies including basic rail assemblies 210B and actuated rail assemblies 210A. Similarly, as used in the present disclosure, reference number 210D generically applies to various rail assemblies 210 mounted or configured to mount on the driver's side 158D of the box 150. Similarly, as used in the present disclosure, reference number 210P generically applies to various rail assemblies 210 mounted or configured to mount on the passenger's side 158P of the box 150.

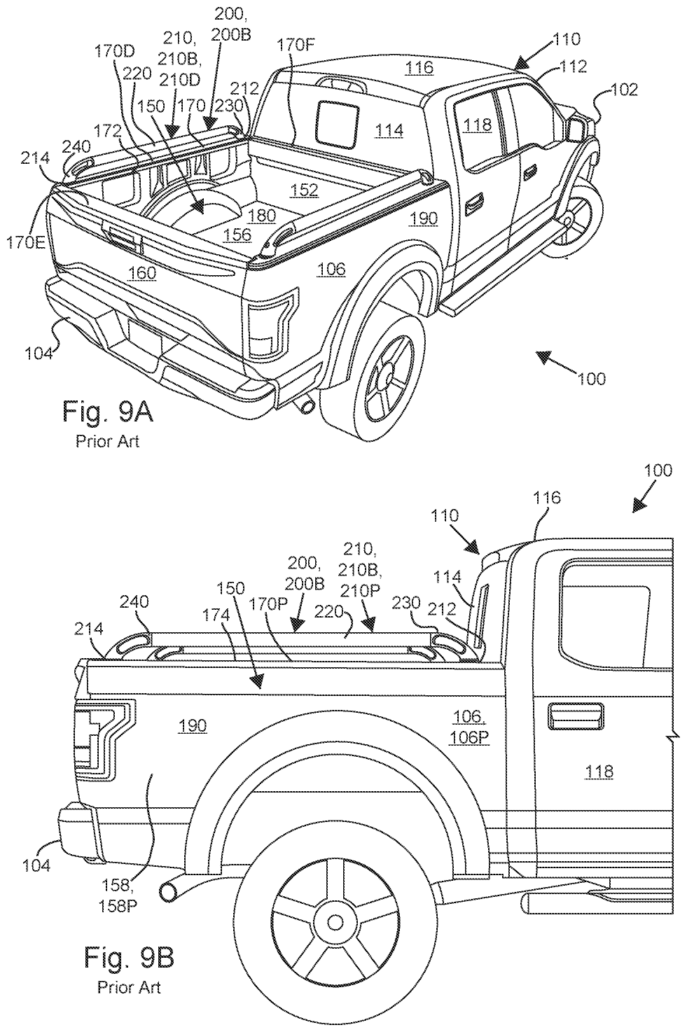

As shown at FIGS. 9A and 9B, a pair of prior art rail assemblies 210, 210B, 210D, 210P may be positioned at sides 158 (i.e., the driver's side 158D and/or the passenger's side 158P) of the box 150. The basic rail assemblies 210B are unpowered and passive. Thus, the pair of the prior art rail assemblies 210 of FIGS. 9A and 9B may be basic rail assemblies 210B, and the rail arrangement 200 of FIGS. 9A and 9B may be a basic rail arrangement 200B. According to the principles of the present disclosure, the basic rail arrangements 200B can serve as the rail arrangement 200 that guides and/or supports at least some of the plurality of panels 500, 500ₙ, in certain embodiments of the retractable cover 50, and thereby serve an unconventional purpose(s) of panel guiding and/or panel supporting in addition to their conventional purposes (i.e., cargo tie-down anchors, grab handles, protection of the box 150, etc.).

In certain embodiments of the present disclosure, the prior art rail arrangement of FIGS. 9A and 9B may be inadequate for the guiding and/or supporting purpose(s) of the rail arrangement 200 (e.g., geometry of a front mount 230 and/or a rear mount 240 of the prior art rail assembly 210B may unacceptably limit overall movement of the panels 500, 500ₙ). Thus, in certain embodiments of the retractable cover 50 (e.g., those requiring a long stroke on the rail assemblies 210 and/or useable stroke near the front end 152 of the box 150), the prior art rail assemblies of FIGS. 9A and 9B do not qualify as basic rail assemblies 210B suitable for use with the retractable cover 50, and the prior art rail arrangement of FIGS. 9A and 9B does not qualify as a basic rail arrangement 200B suitable for use with the retractable cover 50.

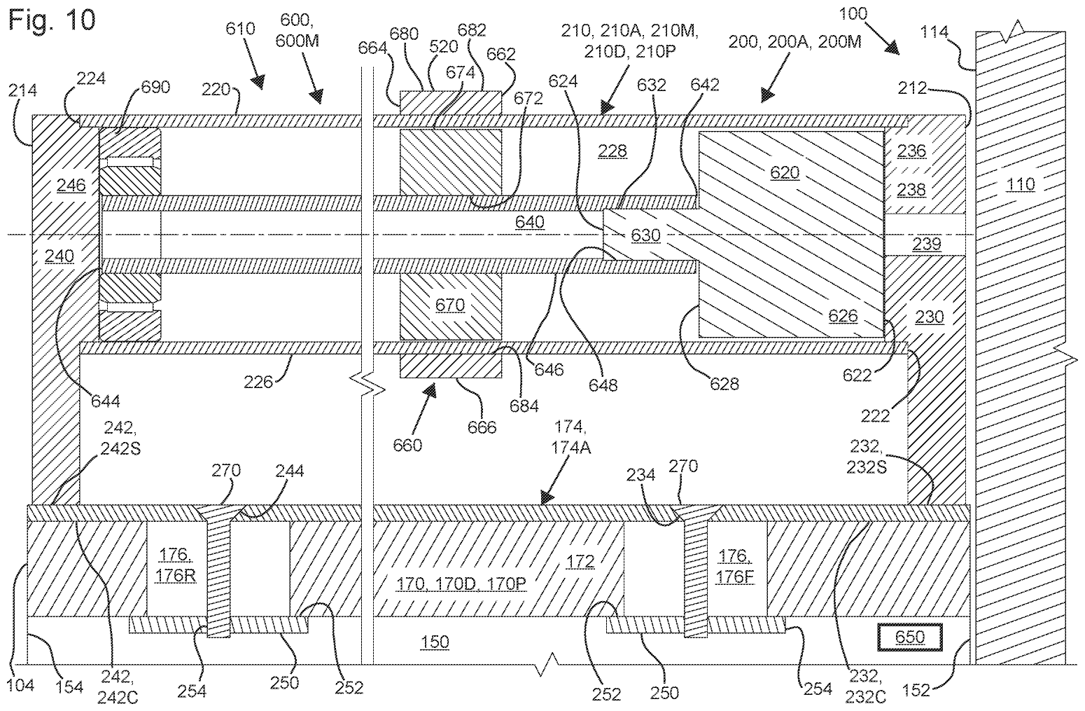

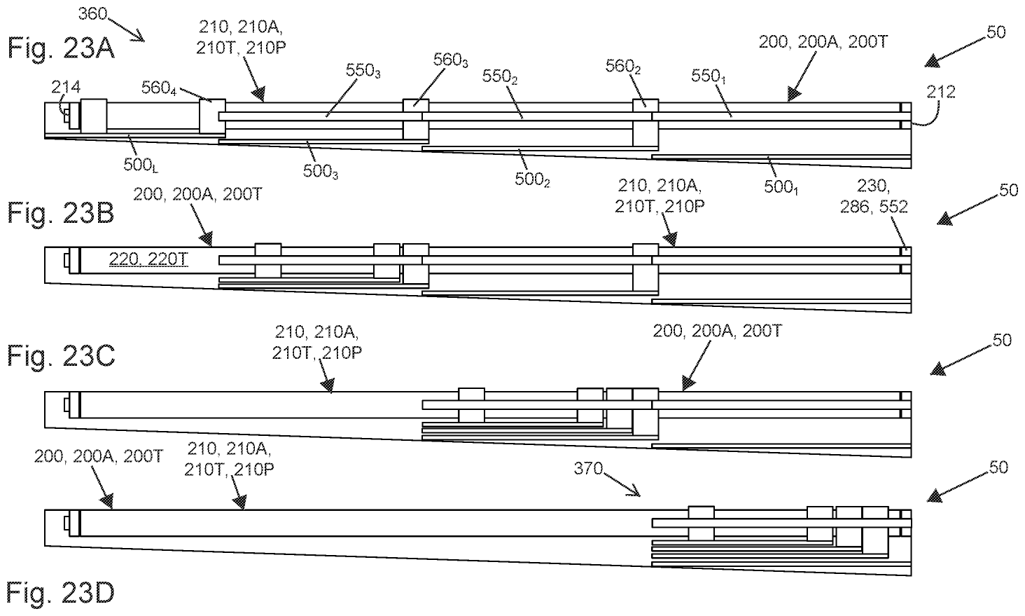

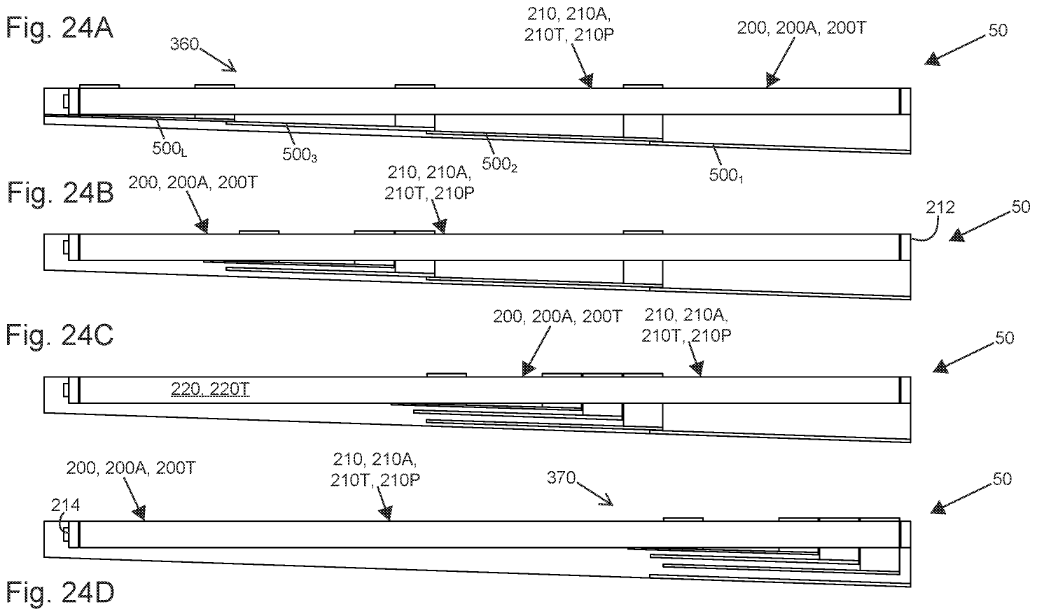

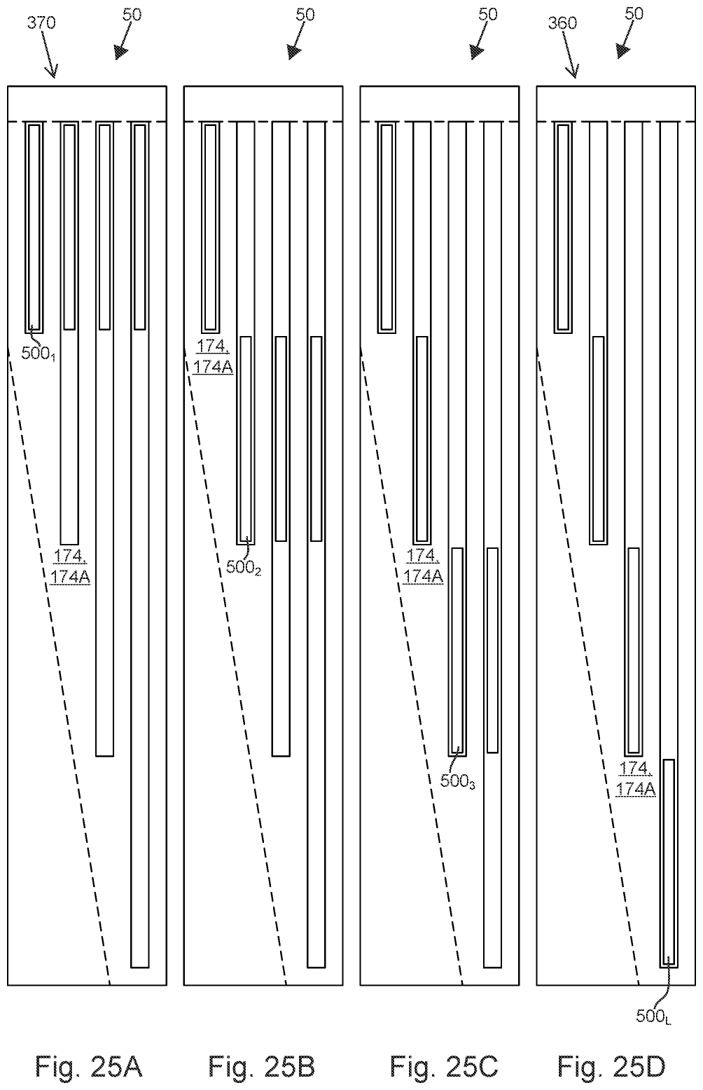

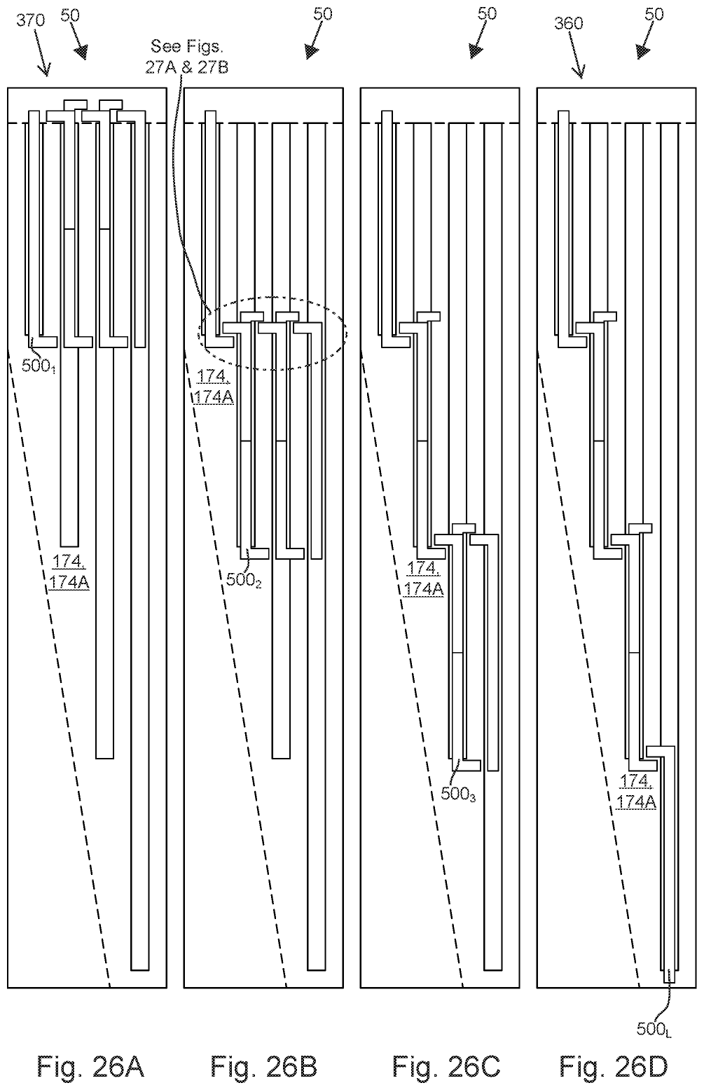

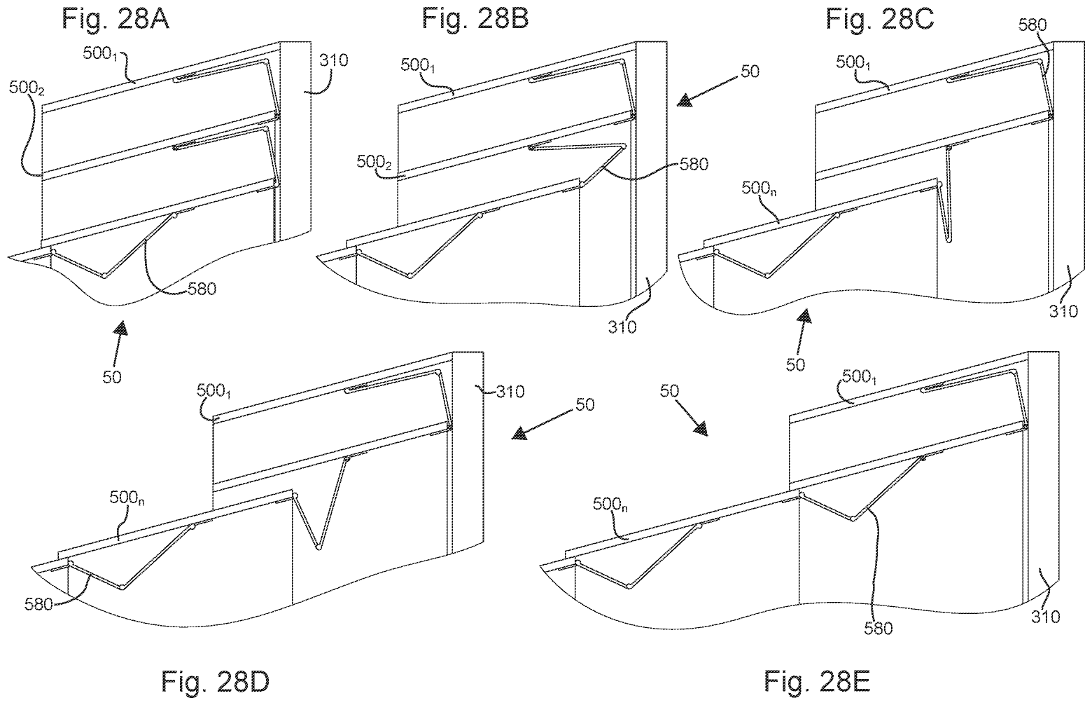

According to the principles of the present disclosure, the front mount 230, 286 of the rail assembly 210 may be compact and/or mounted at or near the front end 152 of the box 150 (see FIGS. 10, 12, 13, and 22A-24D). According to the principles of the present disclosure, the front mount 230, 286 of the rail assembly 210 may be integrated into the rear end 114 of the cab 110 of the pick-up truck 100 (not shown).

The reference number 200A generically applies to actuating rail arrangements, described in detail hereinafter. Various actuating rail arrangements 200A may include exposed thread rail arrangements 200T and magnetically coupled rail arrangements 200M. Similarly, as used in the present disclosure, reference number 210A generically applies to various actuating rail assemblies including externally threaded actuating rail assemblies 210T and magnetically coupled actuating rail assemblies 210M. In certain embodiments, the actuating rail arrangements 200A may perform at least some of the functions of the basic rail arrangements 200B. In certain embodiments, the actuating rail assemblies 210A may perform at least some of the functions of the basic rail assemblies 210B.

The actuating rail arrangements 200A, exposed thread rail arrangements 200T, magnetically coupled rail arrangements 200M, actuated rail assemblies 210A, externally threaded actuating rail assemblies 210T, and/or magnetically coupled actuating rail assemblies 210M may have uses and/or applications beyond pick-up trucks 100 and/or other vehicles, do not necessarily need to be used in pairs, and/or do not necessarily need to accommodate use on pick-up trucks 100 and/or other vehicles.

The reference number 200M generically applies to magnetically coupled rail arrangements, described in detail hereinafter. Various magnetically coupled rail arrangements 200M may include rodless pneumatic rail arrangements and magnetically coupled rail arrangements with an internal deterministic drive (e.g., a drive screw, a timing belt, etc.). Similarly, as used in the present disclosure, reference number 210M generically applies to various actuating rail assemblies including magnetically coupled actuating rail assemblies. Various magnetically coupled rail assemblies 210M may include rodless pneumatic rail actuators and magnetically coupled rail actuators with an internal deterministic drive (e.g., a drive screw, a timing belt, etc.).

In certain embodiments, an actuating rail arrangement 200A may include at least one of the actuating rail assemblies 210A and at least one of the basic rail assemblies 210B. (E.g., the driver's side rail assembly 210D may be the actuating rail assembly 210A, and the passenger's side rail assembly 210P may be the basic rail assembly 210B, or vice-versa.) However, where one or more of the plurality of panels 500, 500ₙ is flexible and/or subject to binding, it may be desirable to have the driver's side rail assembly 210D and the passenger's side rail assembly 210P both be either the actuating rail assemblies 210A or the basic rail assemblies 210B.

In certain embodiments, an actuating rail arrangement 200A may include at least one of the actuating rail assemblies 210A that is pneumatically powered. (E.g., the driver's side rail assembly 210D and/or the passenger's side rail assembly 210P may include a rodless pneumatic air cylinder.) However, where one or more of the plurality of panels 500, 500ₙ is flexible and/or subject to binding, it may not be desirable to use pneumatically powered actuators as they may not be deterministic (i.e., they may have a move profile that may not be repeatable and/or adequately synchronizable).

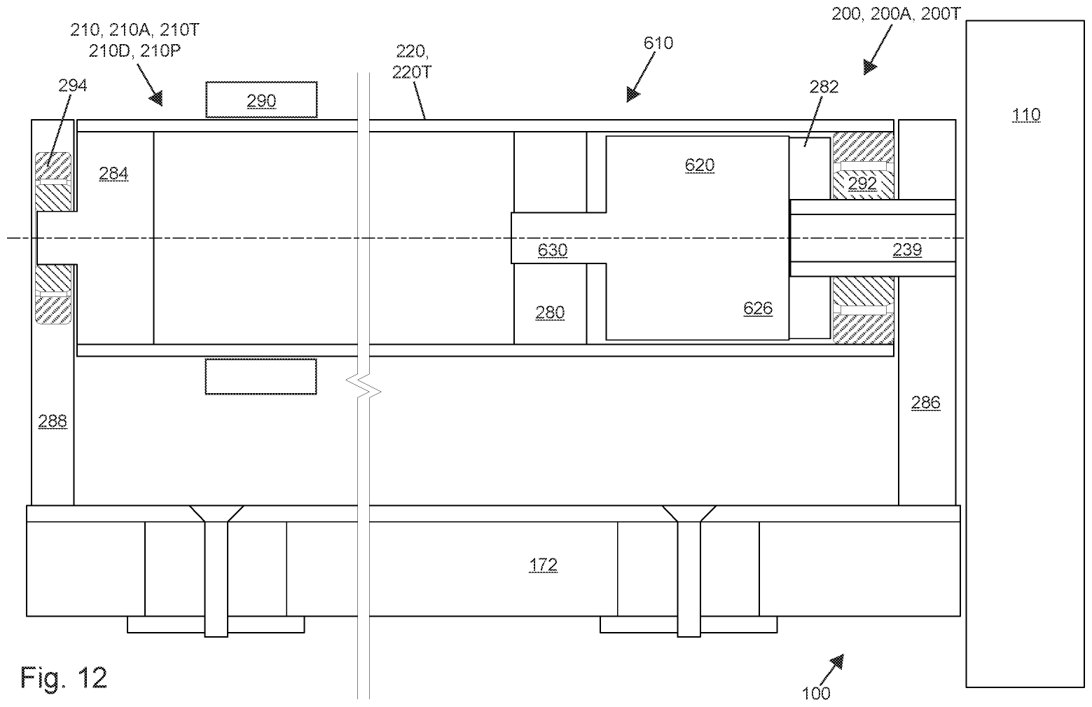

In certain embodiments, it may be desirable to use two or more deterministic actuating rail systems as they may be synchronized to each other and thereby minimize binding and/or bending of flexible object(s) carried and/or actuated by the plurality of actuators. (E.g., it may be desirable to move the plurality of panels 500, 500ₙ with the pair of magnetically coupled deterministic actuators depicted at FIGS. 10 and/or 11 and/or a pair of the externally threaded deterministic actuators depicted at FIGS. 12 and/or 13.)

Turning now to FIGS. 1, 3A, 3B, 7, 9A, and 9B, related and relevant features of the typical pick-up truck 100 are illustrated. At FIG. 7, the box 150 of the pick-up truck 100 is without a cover and without rails. The box 150 extends between the front end 152 and a rear end 154 and between the driver's side 158D and the passenger's side 158P. The cab 110 of the pick-up truck 100 is adjacent the front end 152 of the box 150, and an end gate 160 is at the rear end 154 and shown at a closed position. A bed 156 is at a bottom of the box 150.

As depicted at FIG. 7, a top 170 of the box 150 generally extends around a perimeter of the box 150. In particular, at the front end 152, a top 170F extends between the sides 158D, 158P; at the side 158D, a top 170D extends between the front end 152 and the rear end 154; at the end gate 160, a top 170E extends between the sides 158D, 158P; and at the side 158P, a top 170P extends between the front end 152 and the rear end 154. A flange 172 may extend inwardly around the perimeter of the box 150, especially at the tops 170D, 170P. A cover 174 may cover the tops 170D, 170P, 170F, 170E.

As illustrated at FIG. 10, one or more stake holes 176 may be included on the flange 172 through the tops 170D, 170P. In newer pick-up trucks 100, the covers 174 over the tops 170D, 170P may cover the stake holes 176, and cut-outs may be provided on the covers 174 to access the stake holes 176. The rail assemblies 210, 210D, 210P, 210A, 210B, 210T, and 210M of the rail arrangements 200, 200A, 200B, 200T, and 200M may be mounted to the pick-up truck 100 at the stake holes 176 either directly or indirectly.

For example, a pair of the rail assemblies 210B of FIG. 8A are directly mounted to the pick-up truck 100 of FIGS. 9A and 9B at a respective pair of front stake holes 176F and at a respective pair of rear stake holes 176R. In particular, a mounting surface 252 of a retainer 250 of FIG. 8D may be positioned under the flange 172 adjacent the corresponding stake hole 176, and a fastener (not shown) may join a fastener interface 254 to a fastener interface 234, 244. Mounting surfaces 232, 232S, 242, 242S of the rail assemblies 210, 210B may thus be drawn to the respective top 170, and the rail assemblies 210, 210B directly attached. (The cover 174 and/or a washer/spacer/adapter 260 of FIG. 8C may be positioned between the mounting surface 232, 242 and the top 170).

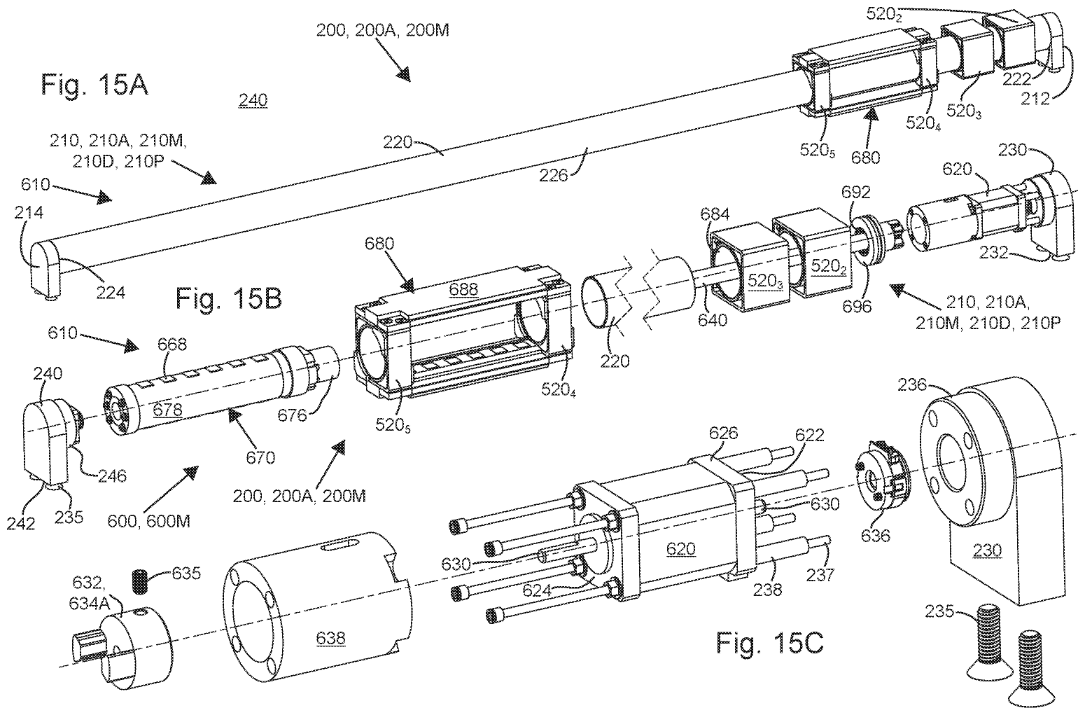

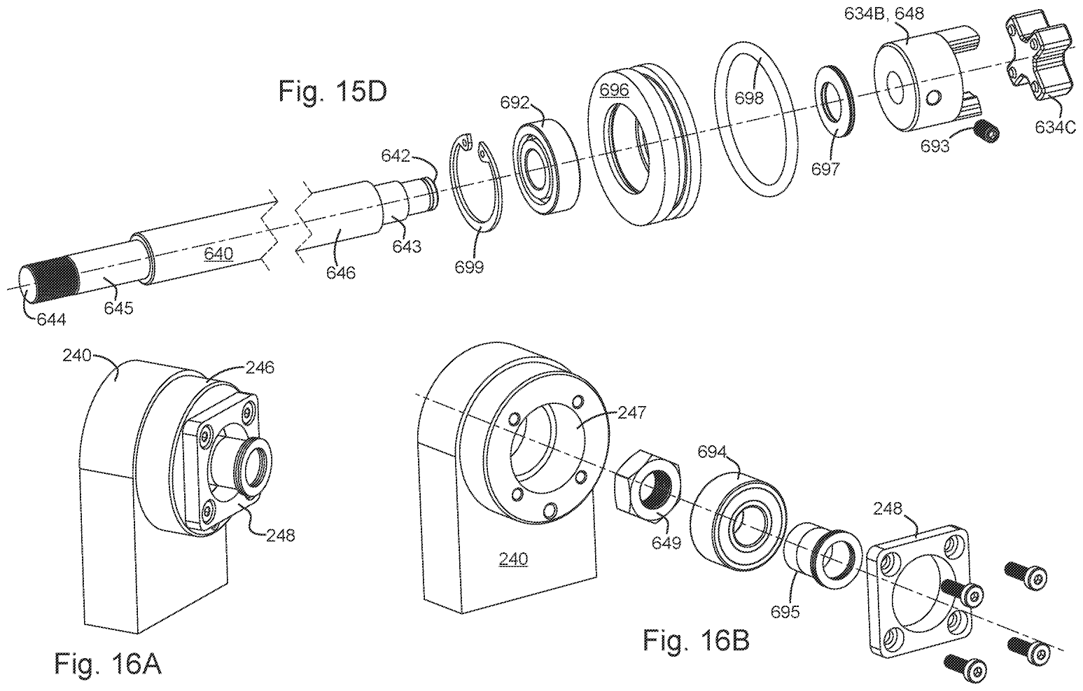

For another example, according to the principles of the present disclosure, the rail assemblies 210, 210A, 210T of FIGS. 2B-2D, 10, and 12-14B may be indirectly attached to corresponding stake holes 176, 176F, 176R. In particular, a pair of covers/mounting brackets 174, 174A may be respectively positioned at the tops 170D, 170P and attached to the stake holes 176, 176F, 176R by respective retainers 250 and fasteners 270. In turn, fasteners 235 may join the front mount 230 and/or the rear mount 240 to the pair of covers/mounting brackets 174, 174A from below (see FIGS. 15B and 15C). The rail assemblies 210 may thereby be joined to the pick-up truck 100 at the stake holes 176 with no fasteners visible at the rail assemblies 210. (The cover 174 of FIG. 7 and/or the washer/spacer/adapter 260 of FIG. 8C may be positioned between the covers/mounting brackets 174, 174A of FIG. 2B and the top 170, or the covers/mounting brackets 174, 174A of FIG. 2B may replace the cover 174 of FIG. 7.) Furthermore, the fasteners 270 may be reversed from what is shown at FIG. 10, and the fastener interfaces 234, 244 of FIG. 10 may be replaced by blind threaded holes with a downward opening (within a downward extending boss). On pick-up trucks 100 with access to the stake holes 176 from below, reversing the fasteners 270 and implementing such blind threaded holes may thereby result in no fasteners being visible at the covers/mounting brackets 174, 174A by casual observers at typical viewing perspectives (i.e., a hidden fastener configuration is possible).

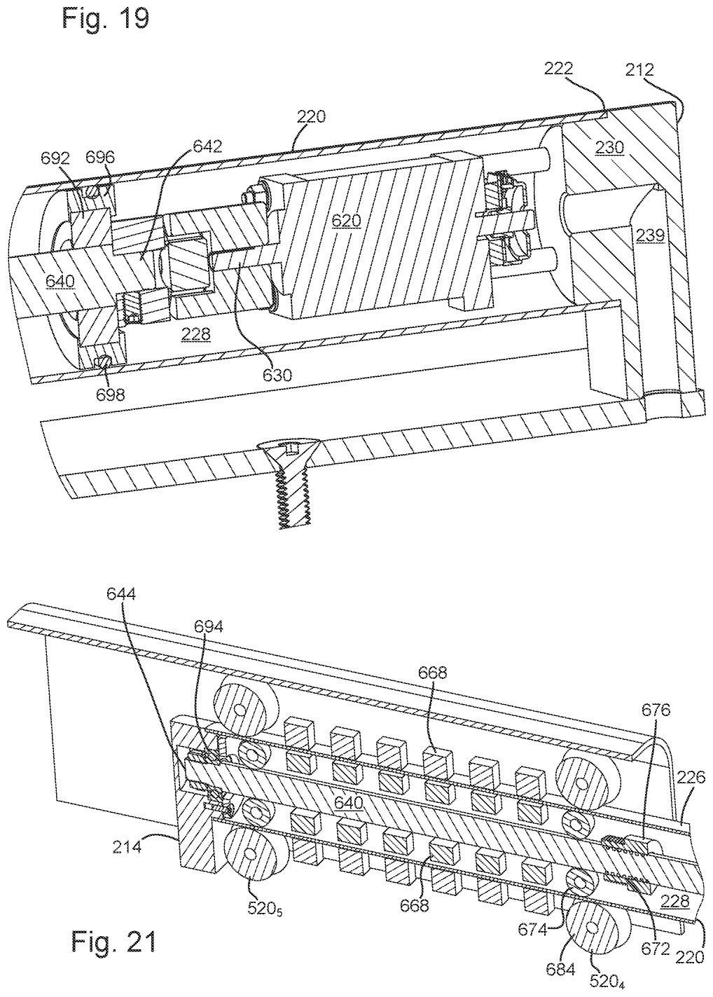

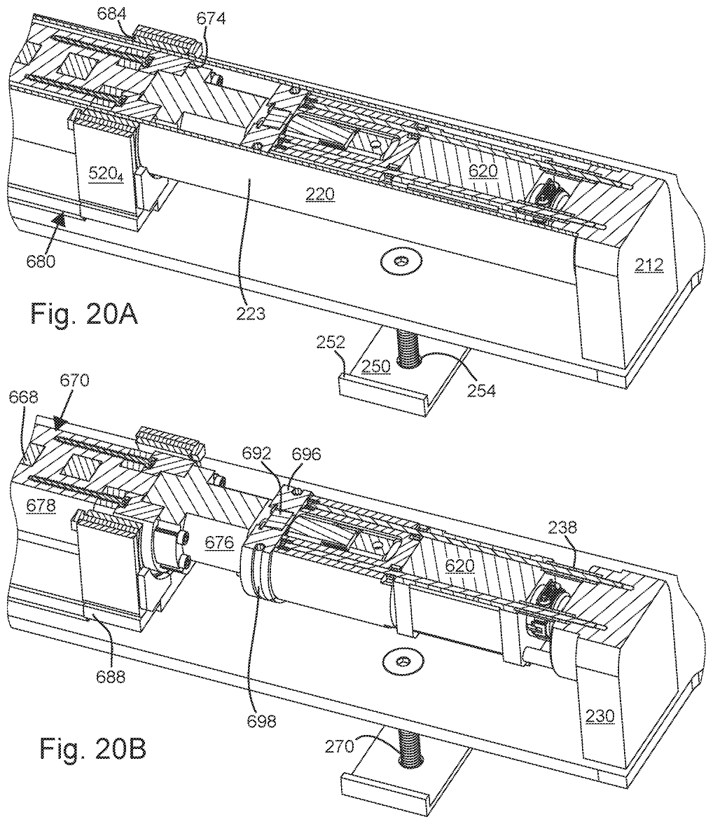

Turning now to FIGS. 2B-2D, 10, 11, and 15A-21, an example rail assembly that illustrates the above-mentioned rail assembly 210, 210A, 210M will now be described in detail according to the principles of the present disclosure. If a motor 620 (e.g., an electric motor, a stepper motor, a servo motor, a pneumatic motor, a motor/gearbox, etc.) is deterministic (i.e., produces a deterministic and/or synchronizable move profile), then the rail assembly 210M will further be a deterministic rail assembly 210M. Certain features of the rail assembly 210A, 210M are employable in a drive arrangement 610 that may have general use as an actuator in a drive system 600, 600M.

The rail assembly 210, 210A, 210M extends between a first end 212 (e.g., a front end) and a second end 214 (e.g., a rear end). The first support bracket 230 (e.g., a mounting bracket, a mount, a front mount, a first mount etc.) is positioned at the first end 212, and the second support bracket 240 (e.g., a mounting bracket, a mount, a rear mount, a second mount, etc.) is positioned at the second end 214. A tube 220 (i.e., a rail, a rail tube, etc.) is mounted between the first support bracket 230 and the second support bracket 240. The tube 220 may be cylindrical in certain embodiments. In other embodiments, the tube 220 may be non-circular (e.g., square, oval, obround, etc.). In the depicted embodiment, the tube 220 has a continuous perimeter along a substantial portion of its length or an entirety of its length between the ends 212, 214. In the depicted embodiment, a tube interface 236 (e.g., a pilot, a threaded pilot, etc.) of the bracket 230 engages a first end 222 of the tube 220, and a tube interface 246 (e.g., a pilot, a threaded pilot, etc.) of the bracket 240 engages a second end 224 of the tube 220. As depicted, an inner surface 228 of the tube 220 is engaged by the tube interfaces 236, 246. In other embodiments, an outer surface 226 of the tube 220 may be engaged by the tube interfaces 236, 246. In the depicted embodiment, the tube interfaces 236, 246 protrude into the tube 220. In certain embodiments, the tube 220 may protrude into the tube interfaces 236, 246.

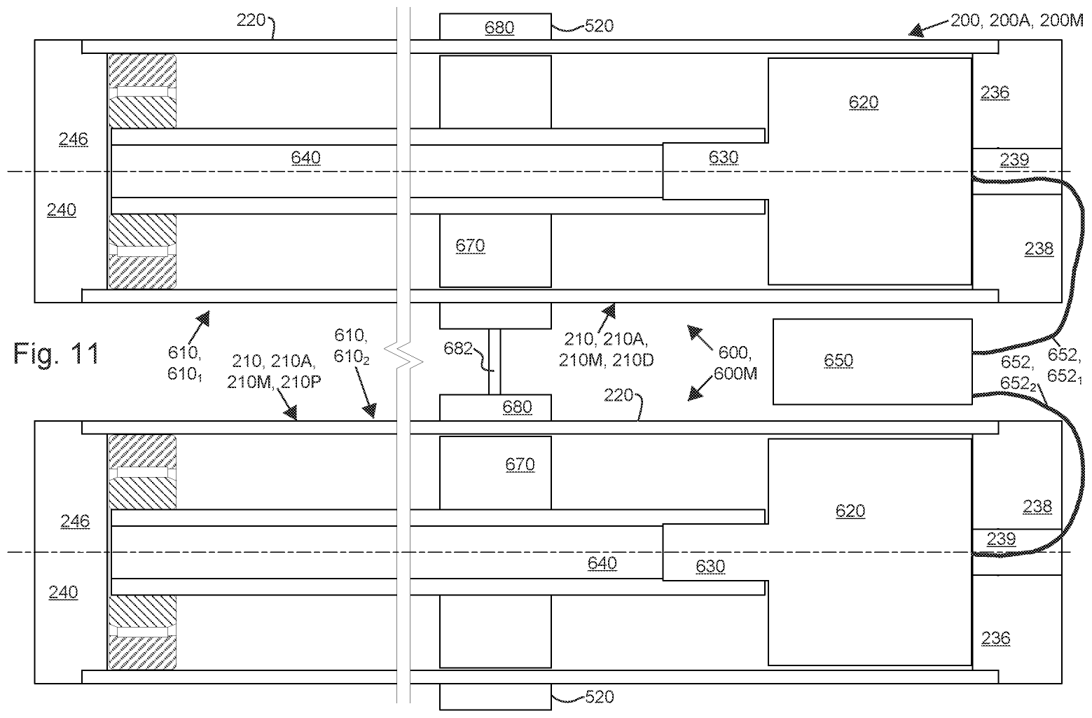

As depicted at FIGS. 2C, 2D, 10, 11, 14B, 15A, 15B, 19, and 20A, the motor 620 is positioned fully (i.e., entirely) within the tube 220. In other embodiments, the motor 620 may be positioned partially within the tube 220 or outside of the tube 220. In the depicted embodiments, the motor 620 is mounted to a motor mount 238 of the first support bracket 230, and a wire passage 239 of the bracket 230 permits electrical power and/or signal wires to pass through the bracket 230 (e.g., in one or more wiring harnesses 652, 652₁, 652₂, as shown at FIG. 11). In other embodiments, the bracket 230 may be integrated with electrical power and/or signal conductors for the motor 620. The electrical power and/or signal wires may further pass between the cover/mounting bracket 174A and the tops 170, 170D, 170P and/or through the stake hole(s) 176 into a body of the pick-up truck 100 and thereby be hidden and/or protected. In the depicted embodiments, a single motor 620 is shown per each of the rail assemblies 210, 210A, 210M. In other embodiments, two or more of the motors 620 (e.g., one motor 620 at each of the support brackets 230, 240) may be used.

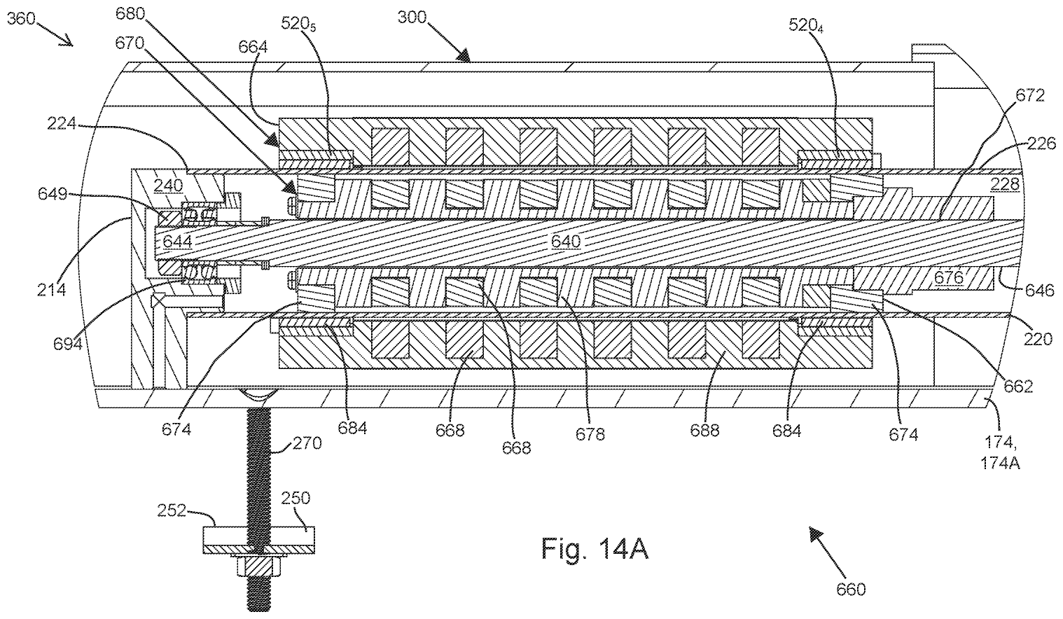

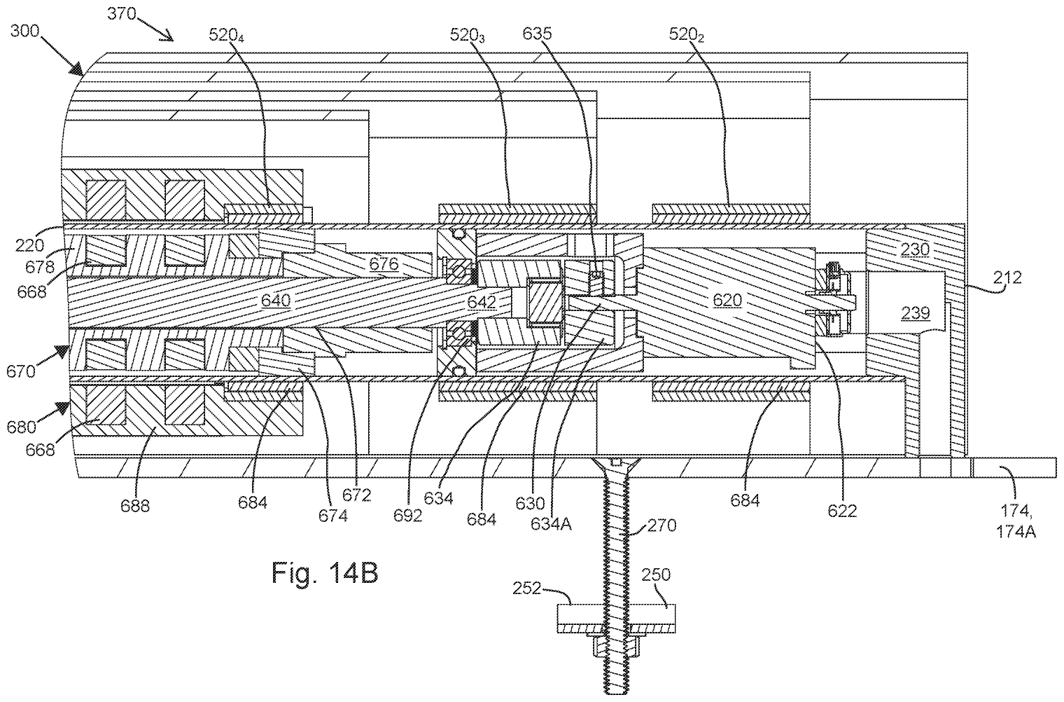

As depicted at FIGS. 10 and 11, an output shaft 630 of the motor 620 engages a first end 642 of a screw 640 (e.g., a drive screw, a lead screw, a ball screw, an acme threaded screw, etc.), and a bearing arrangement 690 rotatably supports a second end 644 of the screw 640. The output shaft 630 may be coupled to the first end 642 of the screw 640 by an interface 648 of the screw 640 interfacing with an interface 632 of the motor 620 and/or the shaft 630. (The bearing arrangement 690 may include one or more bearings of the motor 620, and/or the screw 640 and the output shaft 630 may be integrated/combined.) As depicted at FIGS. 14A, 14B, 15B-16B, 19, 20A, and 20B, the bearing arrangement 690 includes a first bearing 692 supporting the first end 642 of the screw 640 and a second bearing 694 supporting the second end 644 of the screw 640, and a. As shown at FIGS. 14B, 15B, 15D, 19, 20A, and 20B, the first bearing 692 is mounted in a bearing adapter 696 and captured therein by a retainer 699 (e.g., a snap ring). The bearing adapter 696 is adapted to fit within the inner surface 228 of the tube 220, and the first bearing 692 thereby receives support from a mid-portion 223 of the tube 220. An O-ring 698 or similar device may be positioned about the bearing adapter 696 to keep the bearing adapter 696 from spinning or rattling within the tube 220. As shown at FIGS. 14A, 15D, 16A, 16B, and 21, a bearing seat 247 within the second mount 240 supports the second bearing 694. The second bearing 694 may be captured within the bearing seat 247 by a bearing retainer 248. The second bearing 694 may thus further carry thrust (i.e., axial) loads in both directions from the screw 640 and transfer them to the second mount 240.

As further shown, a screw sub-assembly may be sub-assembled that includes the screw 640, and the screw sub-assembly can be installed (i.e., inserted) through the second end 224 of the tube 220. Components at either end 642, 644 of the screw 640 may be installed first. An internal magnetic coupling 670 (described in detail below) along with a corresponding nut 676 (drive nut, ball nut, lead nut, etc.), described in detail below, should be sub-assembled to the screw 640 prior to the components at both ends being installed. In particular, the first bearing 692 (retained in the bearing adapter 696 by the retainer 699 with the O-ring 698 mounted thereon) may be positioned on a bearing journal 643 adjacent a shoulder adjacent drive threads 646 at the first end 642 of the screw 640. To capture the first bearing 692 on the bearing journal 643, a second hub 634B of a flexible coupling and/or adapter 634 may be secured to the first end 642 of the screw 640 (e.g., by a set screw 693). A bearing spring 697 may be positioned between the second hub 634B and an inner race of the first bearing 692 to keep the inner race from spinning on the bearing journal 643. A rubber spider 634C and/or other coupling device may be installed on the second hub 634B. The bearing retainer 248 and any spacers 695 should be slipped over the second end 644 of the screw 640 prior to the second bearing 694 being installed on a bearing journal 645 adjacent a shoulder adjacent the drive threads 646 at the second end 644 of the screw 640. To capture the second bearing 694 on the bearing journal 645, a nut 649 (e.g., a jam nut) or other retaining device may be applied to the second end 644 of the screw 640. Upon the second bearing 694 being secured to the screw 640, the second mount 240 may be attached to the second bearing 694 by positioning the second bearing 694 into the bearing seat 247 within the second mount 240 and fastening the bearing retainer 248 to the second mount 240.

As further shown, a motor sub-assembly may be sub-assembled that includes the motor 620, and the motor sub-assembly can be installed (i.e., inserted) through the first end 222 of the tube 220. An encoder 636 (or other rotary or linear position monitoring device) may be used. In the depicted embodiment of FIGS. 14B, 15B, 15C, 19, 20A, and 20B, the motor shaft 630 extends past a first end 622 and a second end 624 of a housing 626 of the motor 620. If the encoder 636 is used, it may be sub-assembled to the motor shaft 630 and the housing 626 adjacent the first end 622 of the housing 626 as a first step of sub-assembling the motor sub-assembly. A protection bumper 638 for protecting various components in the event of a crash may be used. If the protection bumper 638 is used, it may be sub-assembled to the motor housing 626 as a second step of sub-assembling the motor sub-assembly. A first hub 634A of the flexible coupling and/or adapter 634 may be secured to the motor shaft 630 (e.g., by a set screw 635) as shown at FIG. 14B. The first mount 230 may be sub-assembled to the motor 620 by the motor mounts 238 and fasteners 237, as depicted at FIG. 15C. In the depicted embodiment, the four fasteners 237 run through the motor housing 626 and the four motor mounts 238. The one or more wiring harnesses 652, 652₁, 652₂ should be appropriately routed (e.g., through the wire passage 239 of the first mount 230). As an alternative to what was mentioned above, the rubber spider 634C may be sub-assembled on the first hub 634A.

Prior to assembling (i.e., inserting) both the screw sub-assembly and the motor sub-assembly into the tube 220, an external magnetic coupling 680 (described in detail below) should be assembled to the tube 220 by sliding it over the tube 220. Upon the screw sub-assembly and the motor sub-assembly being assembled into the tube 220 from opposite ends 222, 224, the first hub 634A and the second hub 634B engage each other (via the rubber spider 634C and/or other connection) thereby connecting the motor 620 with the screw 640. Fastening the covers/mounting bracket 174, 174A (or other member) to each of the first mount 230 and the second mount 240 keeps the first mount 230 and the second mount 240 from separating from the tube 220. Alternatively, the ends 222, 224 of the tube 220 can be internally and/or externally threaded and thereby join to the tube interfaces 236, 246 of the respective mounts 230, 240 which can be correspondingly threaded.

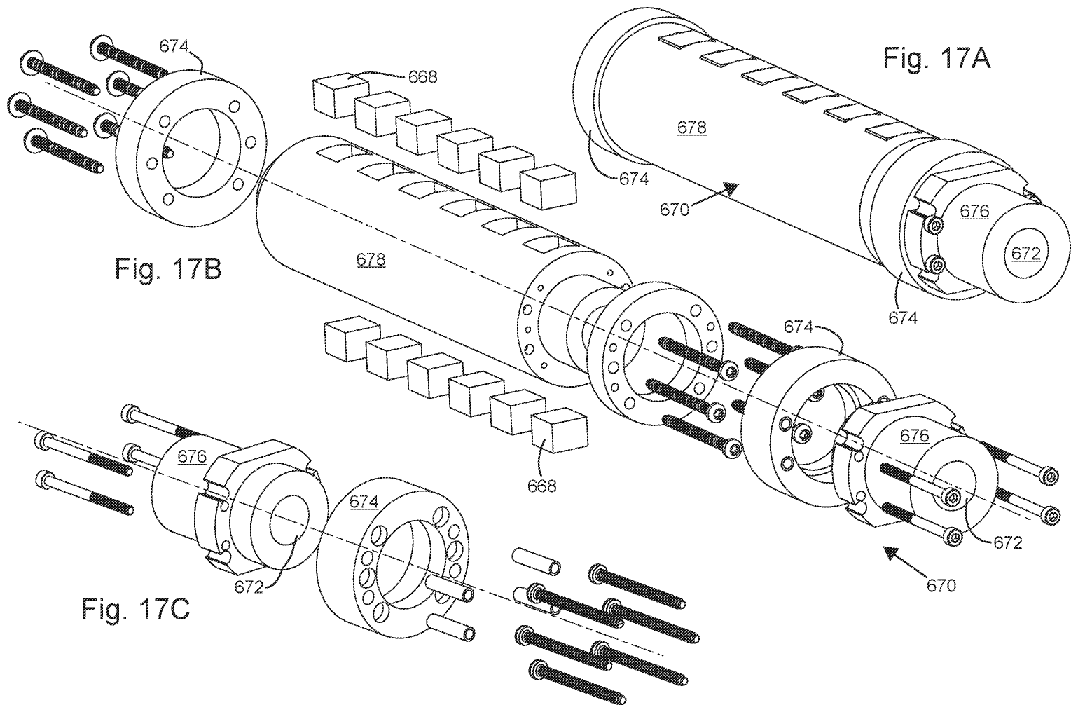

Turning now to FIGS. 17A-17C and 21, the internal magnetic coupling 670 will be described in detail according to the principles of the present disclosure. As mentioned above, the internal magnetic coupling 670 is sub-assembled onto the screw sub-assembly which is then inserted into the tube 220. The screw 640 includes the above-mentioned drive threads 646. The internal magnetic coupling 670 includes an interface portion 672 (e.g., internal threads, drive threads, lead threads, recirculating ball assembly, etc.) that engages the drive threads 646 of the screw 640. The screw 640 thereby engages the internal magnetic coupling 670 of a magnetic coupling arrangement 660. The internal magnetic coupling 670 may include a tube interface 674 (e.g., bushings, wheels, slides, etc.) that interfaces with the inner surface 228 of the tube 220. As depicted at FIGS. 17A-17C, the interface portion 672 is included on a ball nut 676, and the tube interface 674 includes a pair of bushings 674. As depicted at FIG. 21, the interface portion 672 is included on a lead nut 676, and the tube interface 674 includes a set of wheels 674. A coupling body 678 (and various fasteners, glue, sleeves, etc.) attaches the nut 676 (or otherwise attaches the interface portion 672), the tube interface 674, and a set of magnets 668 to each other.

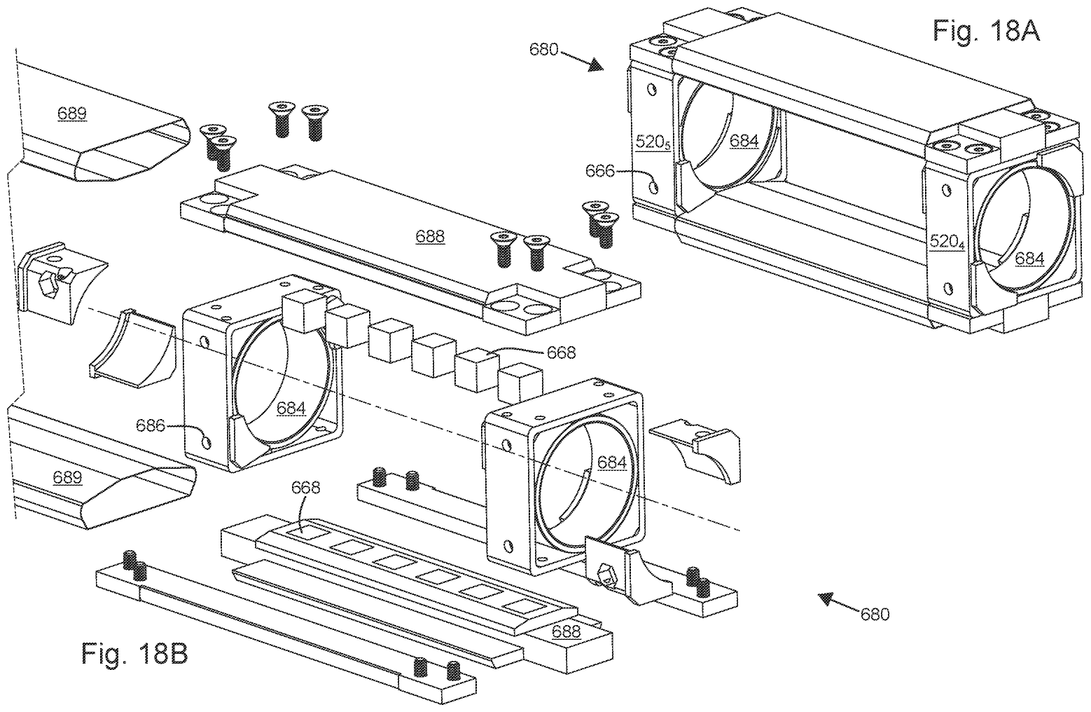

Turning now to FIGS. 18A, 18B, and 21, the external magnetic coupling 680 will be described in detail according to the principles of the present disclosure. As mentioned above, the external magnetic coupling 680 is sub-assembled onto the tube 220 by sliding it over the tube 220. The external magnetic coupling 680 includes one or more external attachment points 686 (e.g., fastener interfaces, welds, adhesives, etc.) that engage an actuated component 300 (e.g., the truck bed cap, box cap, shell, cover, etc. in the depicted embodiments). The external magnetic coupling 680 thereby engages a load or actuated component of the magnetic coupling arrangement 660. The external magnetic coupling 680 may include a tube interface 684 (e.g., bushings, wheels, slides, etc.) that interfaces with the outer surface 226 of the tube 220. As depicted at FIGS. 18A and 18B, the tube interface 684 includes a pair of bushings 684. As depicted at FIG. 21, the tube interface 684 includes a set of wheels 684. A coupling body 688 (and various fasteners, glue, sleeves 689, etc.) attaches the tube interface 684, the external attachment point(s) 686, and a set of magnets 668 to each other.

Upon assembly of the internal magnetic coupling 670 and the external magnetic coupling 680 to the tube 220, the corresponding sets of magnets 668 of the internal magnetic coupling 670 and the external magnetic coupling 680 are magnetically coupled to each other across a wall of the tube 220. The internal magnetic coupling 670 and the external magnetic coupling 680 thereby form the magnetic coupling arrangement 660 and are rotationally and linearly fixed to each other. The tube 220 may be made of non-magnetic material, such as aluminum, plastic, and/or stainless steel or mildly magnetic material, such as certain stainless steel alloys, to avoid or at least substantially avoid magnetic coupling.

The internal magnetic coupling 670 and/or the external magnetic coupling 680 may be held from rotating along an axis of the screw 640 by various anti-rotation means 682. For example, the tube interface 674 and the inner surface 228 of the tube 220 may be non-cylindrical, and/or the external magnetic coupling 680 of the magnetic coupling arrangement 660 may be held from rotating. Thus, as the motor 620 rotates in a first rotational direction, the internal magnetic coupling 670 and the external magnetic coupling 680 are thereby translated along a first translational direction, and as the motor 620 rotates in a second (opposite) rotational direction, the internal magnetic coupling 670 and the external magnetic coupling 680 are thereby translated along a second (opposite) translational direction. As the external magnetic coupling 680 is magnetically coupled to the internal magnetic coupling 670, the external magnetic coupling 680 is indirectly driven by the motor 620.

As illustrated at FIGS. 10 and 18A, the magnetic coupling arrangement 660, and thereby the actuating rail arrangement 200, 200A, 200M includes an external attachment 666 for actuating loads and/or components. The magnetic coupling arrangement 660 extends between a first end 662 and a second end 664.

Turning now to FIGS. 2A, 2B, and 11, a pair of the actuators 200, 200A, 200M, 210, 210A, 210M, 610 of FIGS. 10, 15A, 15B are coupled together with a connection, a component and/or a load. When applied to the retractable cover 50, the connection and/or the load may be the last panel assembly 500L which may be driven by a corresponding pair of the external magnetic couplings 680 (one at each of the two rails 210A, 210M, 210D, 210P). Selecting the internal magnetic coupling 670 and the external magnetic coupling 680 of the magnetic coupling arrangement 660 such that they rotationally and translationally magnetically couple to each other along the axis of the screw 640 allows a parallel pair of the magnetic coupling arrangements 660, spaced apart a distance perpendicular to the axis of the screw 640, to serve as anti-rotate features 682 for each other. The pair of actuators 610 (610₁, 610₂) may be synchronized by feedback or by sending identical stepper pulses or by other methods known in the art. A controller 650 is illustrated at FIG. 11 for this purpose and to supply electrical power to the motors 620.

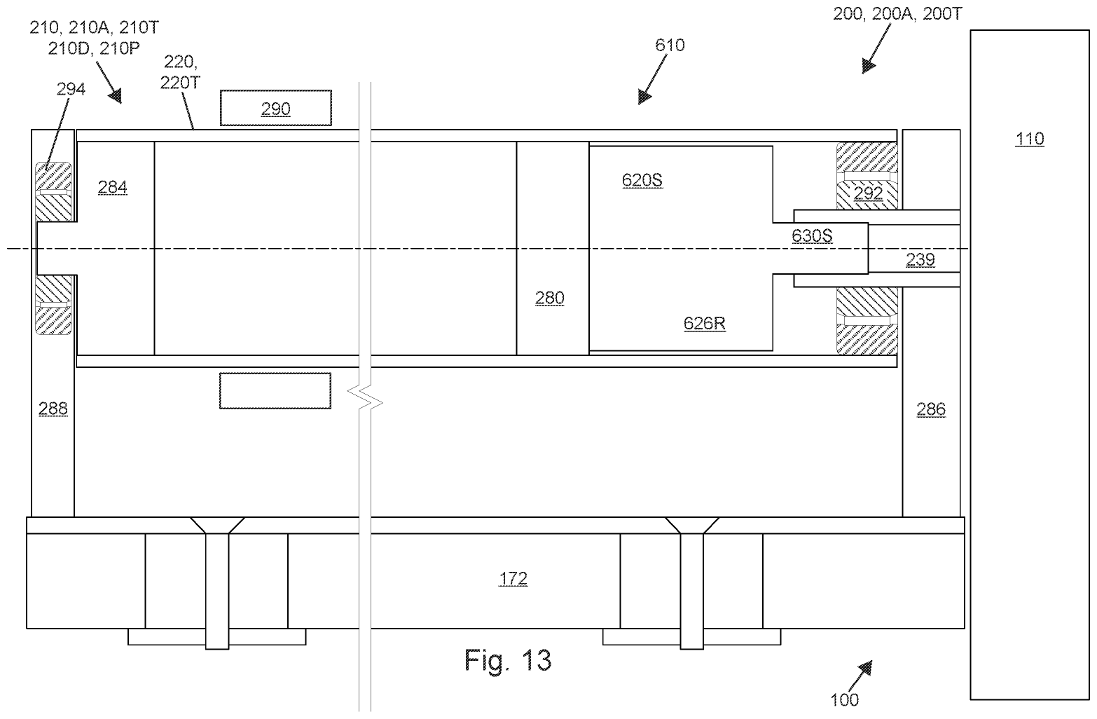

Turning now to FIGS. 12 and 13, an embodiment where externally threaded rails drive the panel assembly 500L of the retractable cover 50 is illustrated. In summary, a nut 290 (i.e., a drive nut) is substantially substituted for the external magnetic coupling 680, mentioned above. The external threads of the tube 220T preferably have a cylindrical outer portion (e.g., as an ACME drive screw does) that allows for the linearly sliding mounts 560 to smoothly slide over the threads.

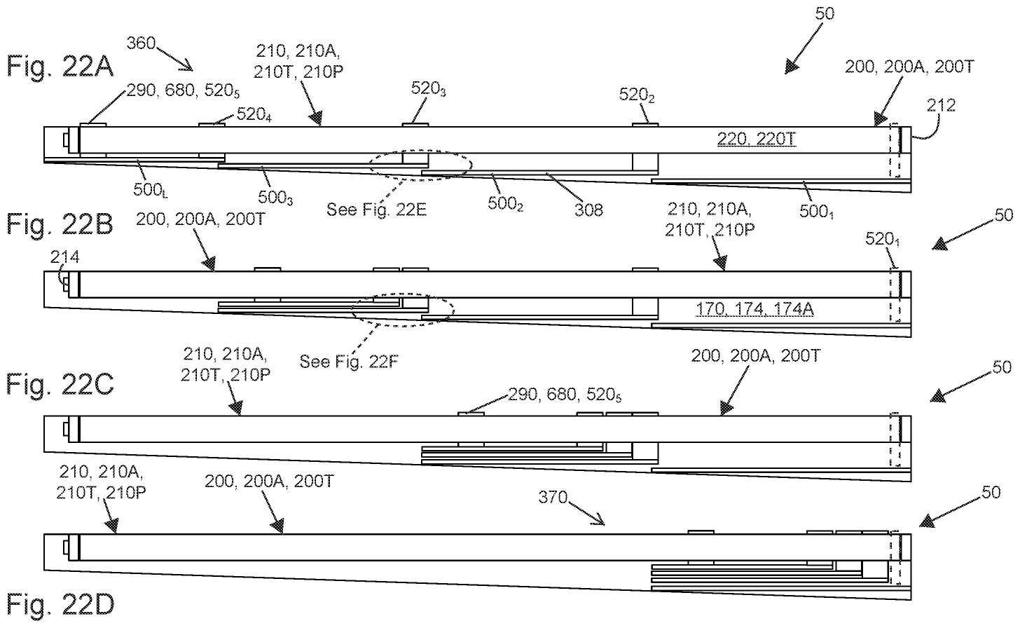

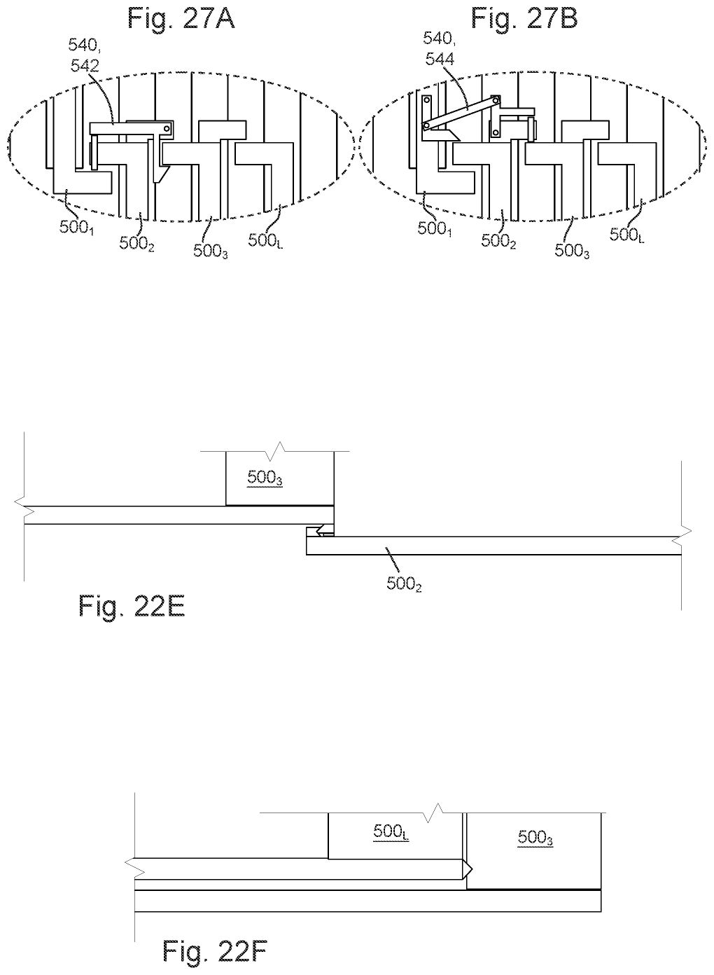

Turning now to FIGS. 22A-22D, 23A-23D, and 24A-24D, portions of various embodiments of the retractable cover 50 are shown that generally correspond to the passenger's side 158P of the box 150. The sliding mounts 520ₙ each ride on their corresponding rail 220, 220T. The last panel assembly 500L is attached to either the external magnetic coupling 680 or the nut 290 of each of the pair of the corresponding actuating rail assemblies 200, 200A, 200M, 210, 210A, 210M, 610. The sequence of panel extension and retraction may be further determined, for example by latches 540 (extending latches 542 and/or retracting latches 544), as illustrated at FIGS. 27A and 27B.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred.

1. A rodless actuator comprising:
a rail tube extending along a length between a first end and a second end;
at least one actuated mount including at least one external tube interface that interfaces with an exterior of the rail tube and thereby supports the at least one actuated mount via the rail tube, the at least one actuated mount positioned outside the rail tube and moveable along at least a first portion of the length of the rail tube;
an external magnetic coupling positioned outside the rail tube and configured to locate the at least one actuated mount at an actuated location along the length of the rail tube;
an internal magnetic coupling positioned within the rail tube and moveable along at least a second portion of the length of the rail tube, the internal magnetic coupling magnetically coupled to the external magnetic coupling and thereby configured to locate the external magnetic coupling along at least a portion of the length of the rail tube; and
a motor positioned at least partially within the rail tube and coupled to the internal magnetic coupling and thereby configured to locate the internal magnetic coupling along at least the second portion of the length of the rail tube and thereby configured to actuate the at least one actuated mount at the actuated location along at least the first portion of the length of the rail tube.

2. (canceled)

3. The rodless actuator of claim 1, wherein the rail tube includes a continuous perimeter extending adjacent to the first end and the second end of the rail tube and wherein the continuous perimeter extends substantially between the first end and the second end of the rail tube.

4.-8. (canceled)

9. The rodless actuator of claim 1, further comprising at least one passive mount, wherein the at least one passive mount includes at least one external tube interface that interfaces with the exterior of the rail tube and thereby supports the at least one passive mount via the rail tube, the at least one passive mount positioned outside the rail tube and moveable along at least a portion of the length of the rail tube.

10. The rodless actuator of claim 1, wherein the at least one external tube interface includes at least one bearing that guides the at least one actuated mount along the rail tube.

11. (canceled)

12. The rodless actuator of claim 10, wherein the at least one bearing of the at least one external tube interface includes at least one bushing that slides along the exterior of the rail tube.

13. The rodless actuator of claim 1, wherein the at least one external tube interface includes at least one roller that rolls along the exterior of the rail tube.

14. The rodless actuator of claim 1, wherein the at least one actuated mount is integrated with the external magnetic coupling.

15. The rodless actuator of claim 1, further comprising at least one anti-rotate feature.

16. The rodless actuator of claim 15, wherein the at least one anti-rotate feature includes a cover segment of a retractable cover.

17. The rodless actuator of claim 1, wherein the internal magnetic coupling includes at least one internal tube interface that interfaces with an interior of the rail tube.

18. (canceled)

19. The rodless actuator of claim 17, wherein the at least one internal tube interface includes at least one roller that rolls along the interior of the rail tube.

20. The rodless actuator of claim 1, wherein the first and second portions of the length of the rail tube are substantially the same.

21. The rodless actuator of claim 1, further comprising a first mount adjacent the first end of the rail tube, the first mount including a fastener-less tube interface that supports the first end of the rail tube.

22. The rodless actuator of claim 21, further comprising a second mount adjacent the second end of the rail tube, the second mount including a fastener-less tube interface that supports the second end of the rail tube.

23. The rodless actuator of claim 22, further comprising a motor mount that attaches the motor of a drive system to the first mount.

24. The rodless actuator of claim 23, wherein the drive system includes a first bearing, a bearing adapter, and a drive screw extending between a first end and a second end, wherein the bearing adapter mounts the first bearing to an interior of the rail tube, and wherein the first bearing rotatably supports the first end of the drive screw.

25.-27. (canceled)

28. The rodless actuator of claim 1, further comprising a first mount adjacent the first end of the rail tube, the first mount including a tube interface that pilots with an interior of the rail tube at the first end of the rail tube.

29. The rodless actuator of claim 28, further comprising a second mount adjacent the second end of the rail tube, the second mount including a tube interface that pilots with an interior of the rail tube at the second end of the rail tube.

30. The rodless actuator of claim 29, further comprising a motor mount that attaches the motor of a drive system to the first mount.

31. The rodless actuator of claim 30, wherein the drive system includes a first bearing, a bearing adapter, and a drive screw extending between a first end and a second end, wherein the bearing adapter mounts the first bearing to an interior of the rail tube, and wherein the first bearing rotatably supports the first end of the drive screw.

32. The rodless actuator of claim 31, wherein the drive system includes a first bearing interface, a second bearing interface, and a second bearing, and wherein the first and second bearing interfaces rotatably attach the second end of the drive screw to the second mount via the second bearing.

33. The rodless actuator of claim 32, wherein the drive system includes a coupling with a first hub and a second hub, wherein the first hub is attached to the motor and is thereby attached to the first mount, and wherein the second hub is attached to the first end of the drive screw and is thereby attached to the second mount.

34. The rodless actuator of claim 33, wherein the coupling further includes a spider positioned between the first and second hubs.

35.-36. (canceled)

37. A rail mounted retractable cover comprising:
a pair of rails, at least one of the pair of rails including the rodless actuator of claim 1; and
a plurality of cover segments;
wherein the at least one actuated mount of the at least one of the pair of rails drives the plurality of cover segments between a deployed configuration and a retracted configuration.

38. (canceled)

39. A retractable aerodynamic apparatus for a pickup truck, the apparatus comprising:
a plurality of panels; and
a pair of rails, at least one of the pair of rails including the rodless actuator of claim 1;
wherein the at least one actuated mount of the at least one of the pair of rails drives the plurality of panels between a deployed configuration and a retracted configuration.

40. The rodless actuator of claim 1, wherein a housing of the motor is positioned at least partially within the rail tube.

41. The rodless actuator of claim 1, wherein a shaft of the motor is positioned at least partially within the rail tube.

42. The rodless actuator of claim 1, wherein a shaft of the motor is fully positioned within the rail tube.

43. The rodless actuator of claim 1, wherein the motor is fully positioned within the rail tube.
